(19) United States
(12) Patent Application Publication
(10) Pub. No.: US 2015/0113569 A1
(43) Pub. Date: Apr. 23, 2015

(54) Reservation System for Watching Online Video

(71) Applicants: Yi-Yun Ning, Taipei City (TW); Tzu-Hsiu Hong, Taipei City (TW)

(72) Inventors: Yi-Yun Ning, Taipei City (TW); Tzu-Hsiu Hong, Taipei City (TW)

(21) Appl. No.: 14/056,196

(22) Filed: Oct. 17, 2013

(51) Int. Cl. H04N 21/472; H04N 21/254

(52) U.S. Cl. CPC H04N 21/47214; H04N 21/2541
USPC 725/58

(57) ABSTRACT

A reservation system for watching online video is used in wireless communication equipment to watch online video via network. The reservation system contains: at least one network server linking to an instant video platform for storing live video medias and for facilitating a user to view and click a desired live video media; a user login interface linking to the plurality of live video medias so as to login and to confirm a user identity; a playing session schedule served to reserve a playing time and a playing session; an online traffic seating chart linking with the playing session schedule so as to confirm viewer's number of the playing time and the playing session, such that the user confirms booking; and a playback information transmission unit linking with the online traffic seating chart and generating playing information based on a booking confirmation and transmitting the playing information to the user.

### BACKGROUND OF THE INVENTION

1. Field of the Invention

The present invention relates to an online reservation system, and more particularly to a reservation system for watching online video.

2. Description of the Prior Art

A conventional reservation method is applied to avoid lining up and to save waiting time, but when a user makes reservation unsuccessfully, he/she cannot save the waiting time.

For example, when desiring to watch theater movies or commercial performances (such as Chinese comic dialogues, musical dramas, or concerts, etc.), customers go on internet platform or go to a convenience store to purchase tickets. Sometimes, when going on the internet, the customers have to login member information so as to make reservation. However, if the booking is full or an ideal screening, time or seat has been booked, the customers line up in sales scene, thus wasting time.

As for as product launches, related sales information is transmitted to the members via short message, e-mail or mail, but if the customers are not a member, they cannot obtain activity message and favorable sales period.

The present invention has arisen to mitigate and/or obviate the afore-described disadvantages.

### SUMMARY OF THE INVENTION

The primary object of the present invention is to provide a reservation system for watching online video which collects a plurality of live video medias (such as theater movies, series videos, business performance (Chinese comic dialogues, musical dramas, or concerts, etc.), real-time product launches, instant on-site press conference, etc.) so that customers go on internet to choose a playing session and a playing time, and watch a plurality of live video medias via at least one wireless communication equipment such as mobile phone, Personal Digital Assistant (PDA), tablet computer, smart phone, smart TV or mobile devices with wireless communication function.

To obtain the above objectives, a reservation system for watching online video is used in wireless communication equipment to watch online video via network.

The reservation system contains: at least one network server linking to an instant video platform for storing live video medias and for facilitating a user to view and click a desired live video media; a user login interface linking to the plurality of live video medias so as to login and to confirm a user identity; a playing session schedule served to reserve a playing time and a playing session; an online traffic seating chart linking with the playing session schedule so as to confirm viewer's number of the playing time and the playing session, such that the user confirms booking; and a playback information transmission unit linking with the online traffic seating chart and generating playing information based on a booking confirmation and transmitting the playing information to the user. Preferably, the reservation system for watching online video further contains a membership database linking with the user login interface so as to set and store personal user's information in the membership database.

Preferably, the membership database includes a prepaid membership account, a personal information modification unit, a recording unit, and a reaction feedback unit.

Preferably, the reservation system for watching online video further contains a setup payment mechanism connecting with the online traffic seating chart so that after the booking, a member/user pays a consumption fee via the setup payment mechanism by means of any one of a credit card account, a phone account of telecommunication company, the prepaid membership account, and an online cash flow mechanism.

Preferably, the reservation system for watching online video further contains a hot playing level unit connecting with the playback information transmission unit, so that after transmitting the playing information, the playback information transmission unit calculates a played number of the plurality of live video medias.

Preferably, the reservation system for watching online video further contains an adding level unit linking with the hot playing level unit and deciding to add a screening number so that the member/user reserves a watching time.

Preferably, the playing information includes an instant-playing ticket number- electronic digital number and a live URL (Uniform Resource Locator) linking website.

Preferably, the reservation system for watching online video further contains an interactive zone in which the members/users have logined through the user login interface to exchange messages.

Preferably, the instant video platform has a security mechanism linking to the video player so as to prevent from illegal loggers or copying.

Preferably, the security mechanism is a Digital Rights Management (DRM).

Another object of the present invention is to provide a reservation system for watching online video which provides favorable information or bonuses (such as a priority to purchase products, favorable offers or discounts of next sales) to VIP members of the plurality of live video medias (such as theater movies, concerts, real-time product launches or instant on-site press conference).

### BRIEF DESCRIPTION OF THE DRAWINGS

FIG. 1 is flow chart of a reservation system for watching online video according to a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

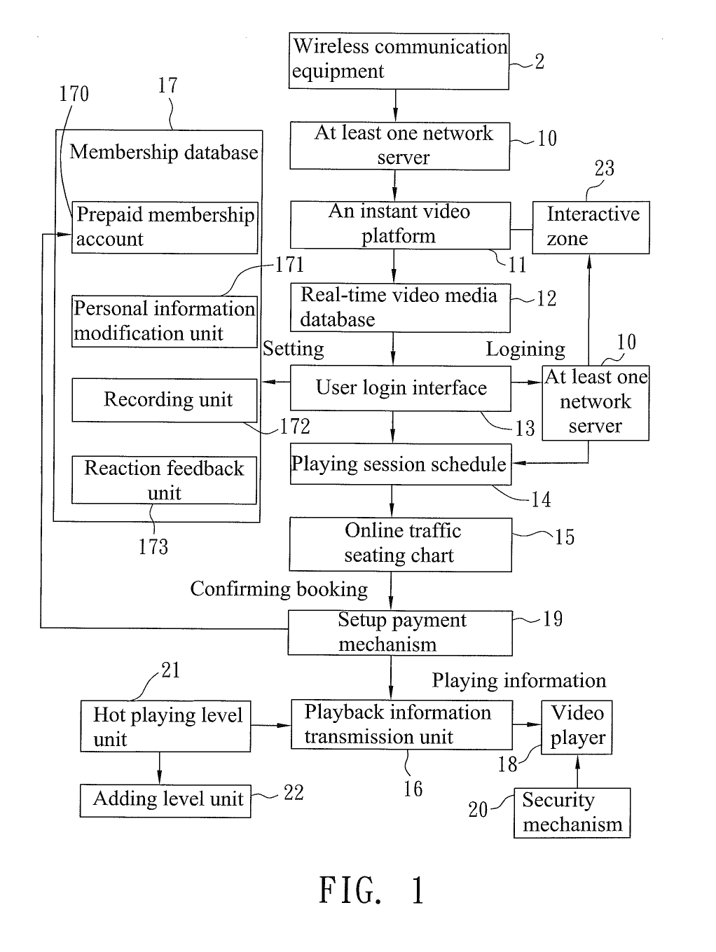

With reference to FIG. 1, a reservation system for watching online video according to a preferred embodiment of the present invention is used in at least one a wireless communication equipment to watch online video via network, a respective one of the at least one a wireless communication equipment 2 is any one of a smart TV, a smart phone, a tablet computer or a computer. The reservation system 1 of the present invention comprises at least one network server 10, an instant video platform 11, a real-time video media database 12, a user login interface 13, a playing session schedule 14, an online traffic seating chart 15, and a playback information transmission unit 16. When a customer is desired to become a member of the instant video platform 11, he/she links to the user login interface 13 and to set and store personal user's information in a membership database 17, and then the customer acquires user's ID and password is logined and then is stored in the membership database 17. The membership database 17 includes a prepaid membership account 170, a personal information modification unit 171, a recording unit 172, and a reaction feedback unit 173. The prepaid membership account 170 is set in the membership database 17 after the customer becomes the member so that the member prepays consumption fee and is charged the consumption fee in advance. The personal information modification unit 171 is provided to correct the personal user's information, and the recording unit 172 records a consumption record on the instant video platform 11 and changes or cancels a reserved screening. The reaction feedback unit 173 is applied to receive member's opinions so as to serve, improve, and solve member's request.

The user applies the at least one network server 10 to link to the instant video platform 11 so as to play a plurality of live video medias (such as theater movies, series videos, business performance (Chinese comic dialogues, musical dramas, or concerts, etc.), real-time product launches, instant on-site press conference, etc.) in the video media database 12 via the instant video platform 11, and the member which has logined or not logined directly clicks and watches a desired live video media. When the user wants to reserve and choose watching time, he/she inputs the user's ID and password through the user login interface 13 so as to confirm a user identity and then links to the playing session schedule 14 by using the user identity so that the user reserves a playing time and a playing session. Thereafter, the user links to the online traffic seating chart 15 so as to confirm viewer's number of the playing time and the playing session, such that the user confirms booking.

After the booking, the playback information transmission unit 16 of the online traffic seating chart 15 generates playing information based on a booking confirmation and transmits the playing information to the user. It is to be noted that the playing information includes an instant-playing ticket number-electronic digital number and a live URL (Uniform Resource Locator) linking website. The playing information is transmitted to the user by ways of short message, e-mail or mail (according to a contact channel written on an application form).

Thereby, the user links to the live URL linking website directly and inputs the instant-playing ticket number (i.e., the electronic digital numbers) to start a video player 18, thus watching the live video media which is reserved in advance.

The live video media in the reservation system is charged or is free, wherein when the live video media is free, it can be watched by any member user without making reservation, i.e., the member user can watch the live video media by free. Furthermore, the booking is confirmed after the consumption fee is charged through a setup payment mechanism 19, wherein the setup payment mechanism 19 connects with the online traffic seating chart 15 so that after the booking, the member user pays the consumption fee via the setup payment mechanism 19 by means of any one of a credit card account, a phone account of telecommunication company, the prepaid membership account, and an online cash flow mechanism.

To prevent from illegal loggers or copying, when starting the video player 18, a security mechanism 20 links to the video player 18 so as to prevent from the illegal loggers or the copying, and wherein the security mechanism 20 is a Digital Rights Management (DRM) to protect a digital protection content (such as software, music, movies) and hardware.

The reservation system of the present invention further comprises a hot playing level unit 21 and an adding level unit 22 linking with the hot playing level unit 21, wherein the hot playing level unit 21 is in connection with the playback information transmission unit 16 so that after transmitting the playing information, the playback information transmission unit 16 calculates a played number of the live video media, and then the adding level unit 22 decides to add an screening number so that the user reserves the watching time.

In addition, when the live video media of the reservation system of the present invention is an instant product launch or a product sales program and is played, the user can purchase products by clicking a product connecting point or calling a phone pointed in the live video media so as to order the product or to pay sales fee via the online cash flow mechanism, thereafter the instant video platform shows order quantity or sales quantity.

Also, the instant video platform links to an interactive zone 23 in which members have logined through the user login interface 13 to exchange messages by using texts and video. Preferably, the messages are exchanged by members who are watching the live video media by ways of the texts, and the texts are displayed in a vertical arrangement.

While we have shown and described various embodiments in accordance with the present invention, it is clear to those skilled in the art that further embodiments may be made without departing from the scope of the present invention.

What is claimed is:

1. A reservation system for watching online video being used in at least one wireless communication equipment to watch online video via network and comprising:
at least one network server linking to an instant video platform;
the instant video platform used to store a plurality of live video medias and to facilitate a user to view and click a desired live video media;
a user login interface linking to the plurality of live video medias so as to login and to confirm a user identity;
a playing session schedule served to reserve a playing time and a playing session;
an online traffic seating chart linking with the playing session schedule so as to confirm viewer's number of the playing time and the playing session, such that the user confirms booking; and
a playback information transmission unit linking with the online traffic seating chart and generating playing information based on a booking confirmation and transmitting the playing information to the user.

2. The reservation system for watching online video as claimed in claim 1 further comprising a membership database linking with the user login interface so as to set and store personal user's information in the membership database.

3. The reservation system for watching online video as claimed in claim 2, wherein the membership database includes a prepaid membership account, a personal information modification unit, a recording unit, and a reaction feedback unit.

4. The reservation system for watching online video as claimed in claim 3 further comprising a setup payment mechanism connecting with the online traffic seating chart so that after the booking, a member pays a consumption fee via the setup payment mechanism by means of any one of a credit card account, a phone account of telecommunication company, the prepaid membership account, and an online cash flow mechanism.

5. The reservation system for watching online video as claimed in claim 1 further comprising a hot playing level unit connecting with the playback information transmission unit, so that after transmitting the playing information, the playback information transmission unit calculates a played number of the plurality of live video medias.

6. The reservation system for watching online video as claimed in claim 5 further comprising an adding level unit linking with the hot playing level unit and deciding to add a screening number so that the user reserves a watching time.

7. The reservation system for watching online video as claimed in claim 1, wherein the playing information includes an instant-playing ticket number- electronic digital number and a live URL (Uniform Resource Locator) linking website.

8. The reservation system for watching online video as claimed in claim 1 further comprising an interactive zone in which the users have logined through the user login interface to exchange messages.

9. The reservation system for watching online video as claimed in claim 1, wherein the instant video platform has a security mechanism linking to the video player so as to prevent from illegal loggers or copying.

10. The reservation system for watching online video as claimed in claim 1, wherein the security mechanism is a Digital Rights Management (DRM).
